(19) United States
(12) Patent Application Publication
(10) Pub. No.: US 2010/0157221 A1
(43) Pub. Date: Jun. 24, 2010

(54) LIQUID CRYSTAL PANEL AND ELECTRONIC APPARATUS

(75) Inventors: Yoshihiro Sakurai, Kanagawa (JP); Hironao Tanaka, Kanagawa (JP); Harumi Okuno, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/640,740

(22) Filed: Dec. 17, 2009

(30) Foreign Application Priority Data
Dec. 19, 2008 (JP) P2008-324782

(51) Int. Cl. G02F 1/1337

(52) U.S. Cl. 349/123

(57) ABSTRACT

A liquid crystal panel includes: first and second substrates arranged to be opposite each other at a predetermined gap; a liquid crystal layer filled between the first and second substrates; a counter electrode pattern formed on the first substrate; a pixel electrode pattern formed on the first substrate; and alignment films formed such that the alignment direction of the liquid crystal layer crosses the extension direction of a slit of the pixel electrode pattern at an angle of 7° or larger.

### CROSS REFERENCES TO RELATED APPLICATIONS

The present application claims priority to Japanese Priority Patent Application JP 2008-324782 filed in the Japan Patent Office on Dec. 19, 2008, the entire contents of which is hereby incorporated by reference.

### BACKGROUND

The present application relates to a transverse electric field driving liquid crystal panel which performs rotation control of the arrangement of liquid crystal molecules in parallel to a substrate surface by a transverse electric field generated between a pixel electrode and a counter electrode. The present application also relates to an electronic apparatus having the liquid crystal panel mounted therein.

At present, liquid crystal panels have various panel structures including a vertical electric field display type in which an electric field is generated in the vertical direction with respect to the panel surface. For example, a transverse electric field display type panel structure is suggested in which an electric field is generated in the horizontal direction with respect to the panel surface.

In the transverse electric field display type liquid crystal panel, the rotation direction of liquid crystal molecules is parallel to the substrate surface. For this reason, unlike the vertical electric field display type liquid crystal panel, a rise of liquid crystal molecules in an oblique direction is small. That is, in the transverse electric field display type liquid crystal panel, there is little rotation of the liquid crystal molecules in the vertical direction with respect to the substrate surface. For this reason, changes in the optical characteristics (contrast, luminance, and color tone) are comparatively small. That is, the transverse electric field display type liquid crystal panel has a wider viewing angle than the vertical electric field display type liquid crystal panel.

FIG. 1 shows an example of the sectional structure of a pixel region constituting a transverse electric field display type liquid crystal panel. FIG. 2 shows an example of the corresponding planar structure.

A liquid crystal panel 1 has two glass substrates 3 and 5, and a liquid crystal layer 7 filled so as to be sandwiched with the glass substrates 3 and 5. A polarizing plate 9 is disposed on the outer surface of each substrate, and an alignment film 11 is disposed on the inner surface of each substrate. Note that the alignment film 11 is used to arrange a group of liquid crystal molecules of the liquid crystal layer 7 in a predetermined direction. In general, a polyimide film is used.

On the glass substrate 5, a pixel electrode 13 and a counter electrode 15 are formed of a transparent conductive film. Of these, the pixel electrode 13 is structured such that both ends of five comb-shaped electrode branches 13A are respectively connected by connection portions 13B. Meanwhile, the counter electrode 15 is formed below the electrode branches 13A (near the glass substrate 5) so as to cover the entire pixel region. This electrode structure causes a parabolic electric field between the electrode branches 13A and the counter electrode 15. In FIG. 1, this electric field is indicated by a broken-line arrow.

The pixel region corresponds to a region surrounded by signal lines 21 and scanning lines 23 shown in FIG. 2. In each pixel region, a thin film transistor for controlling the application of a signal potential to the pixel electrode 13 is disposed. The gate electrode of the thin film transistor is connected to a scanning line 23, so the thin film transistor is turned on/off by the potential of the scanning line 23.

One main electrode of the thin film transistor is connected to a signal line 21 through an interconnect pattern (not shown), and the other main electrode of the thin film transistor is connected to a contact 25. Thus, when the thin film transistor is turned on, the signal line 21 and the pixel electrode 13 are connected to each other.

As shown in FIG. 2, in this specification, a gap between the electrode branches 13A is called a slit 31. In FIG. 2, the extension direction of the slit 31 is identical to the extension direction of the signal line 21.

For reference, FIGS. 3A and 3B show the sectional structure around the contact 25.

JP-A-10-123482 and JP-A-11-202356 are examples of the related art.

### SUMMARY

In the transverse electric field display type liquid crystal panel, it is known that, as shown in FIG. 4, the alignment of the liquid crystal molecules is likely to be disturbed at both ends of the slit 31 (around the connection portion of the electrode branches 13A and the connection portion 13B). This phenomenon is called disclination. In FIG. 4, regions 41 where the arrangement of the liquid crystal molecules is disturbed due to occurrence of disclination are shaded. In FIG. 4, the alignment of the liquid crystal molecules is disturbed at ten regions 41 in total.

If external pressure (finger press or the like) is applied to the disclination, the disturbance of the arrangement of the liquid crystal molecules is expanded along the extension direction of the electrode branches 13A. Note that the disturbance of the arrangement of the liquid crystal molecules is applied such that the arrangement of the liquid crystal molecules is rotated in a direction opposite to the electric field direction. This phenomenon is called a reverse twist phenomenon.

FIG. 5 shows an example of the occurrence of a reverse twist phenomenon. In FIG. 5, regions 43 where the arrangement of the liquid crystal molecules is disturbed are shaded. These regions extend along the extension direction of the electrode branches 13A.

In the case of the liquid crystal panel being used at present, if the reverse twist phenomenon occurs, the original state is not restored after it has been left uncontrolled. This is because the disclination expanded from the upper portion of the pixel is linked with the disclination expanded from the lower portion of the pixel at the central portion of the pixel to form a stabilized state, and the alignment direction of the liquid crystal molecules in the regions 43 is not restored to the original state. As a result, the regions 43 where the reverse twist phenomenon occurs may be continuously viewed as residual images (that is, display irregularity).

An embodiment provides a liquid crystal panel. The liquid crystal panel includes first and second substrates arranged to be opposite each other at a predetermined gap, a liquid crystal layer filled between the first and second substrates, a counter electrode pattern formed on the first substrate, a pixel electrode pattern formed on the first substrate, and alignment films formed such that the alignment direction of the liquid crystal layer crosses the extension direction of a slit of the pixel electrode pattern at an angle of 7° or larger.

The cross angle between the extension direction of the slit and the alignment direction of the liquid crystal layer may be equal to or larger than 7° and equal to or smaller than 15°. Each pixel region may have a plurality of regions where the rotation direction of liquid crystal molecules differs.

The pixel electrode pattern and the counter electrode pattern may be formed on the same layer surface, or may be formed on different layer surfaces. That is, if the liquid crystal panel is a transverse electric field display type liquid crystal panel, and the pixel electrode has a slit, the sectional structure of the pixel region is not limited.

The pixel electrode pattern or the alignment film is formed such that the cross angle between the extension direction of the slit of the pixel electrode pattern and the alignment direction of the liquid crystal layer is equal to or larger than 7°.

With this pixel structure, a display panel can be realized in which, even though the reverse twist phenomenon occurs, the reverse twist phenomenon can be eliminated by itself when the display panel is left uncontrolled.

Additional features and advantages are described herein, and will be apparent from the following Detailed Description and the figures.

### BRIEF DESCRIPTION OF THE FIGURES

FIG. 1 is a diagram illustrating an example of the sectional structure of a transverse electric field display type liquid crystal panel.

FIG. 2 is a diagram illustrating an example of the planar structure of a transverse electric field display type liquid crystal panel.

FIGS. 3A and 3B are diagrams showing an example of the sectional structure around a contact.

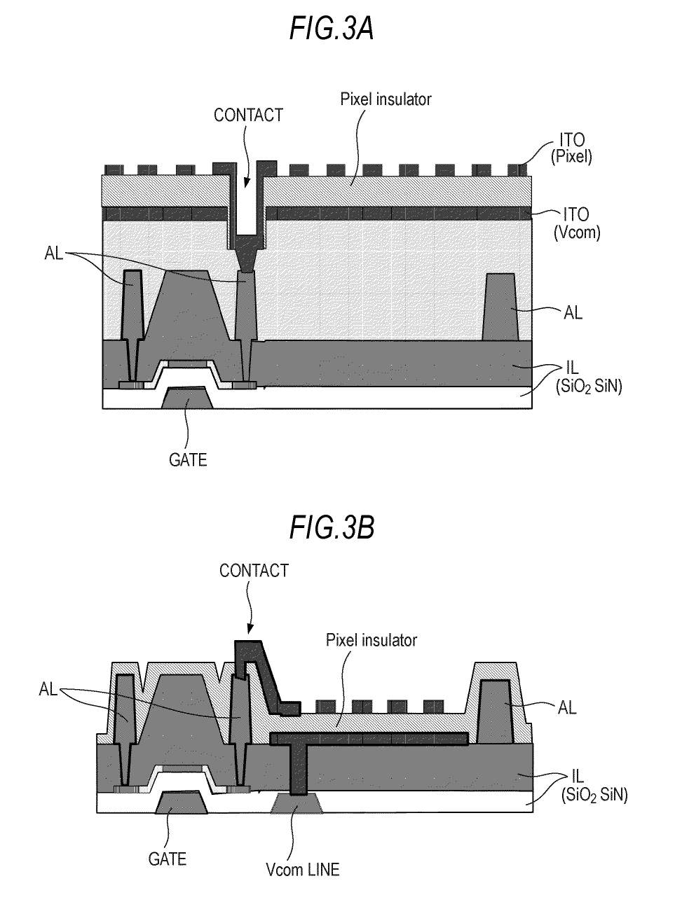

FIG. 4 is a diagram illustrating disclination.

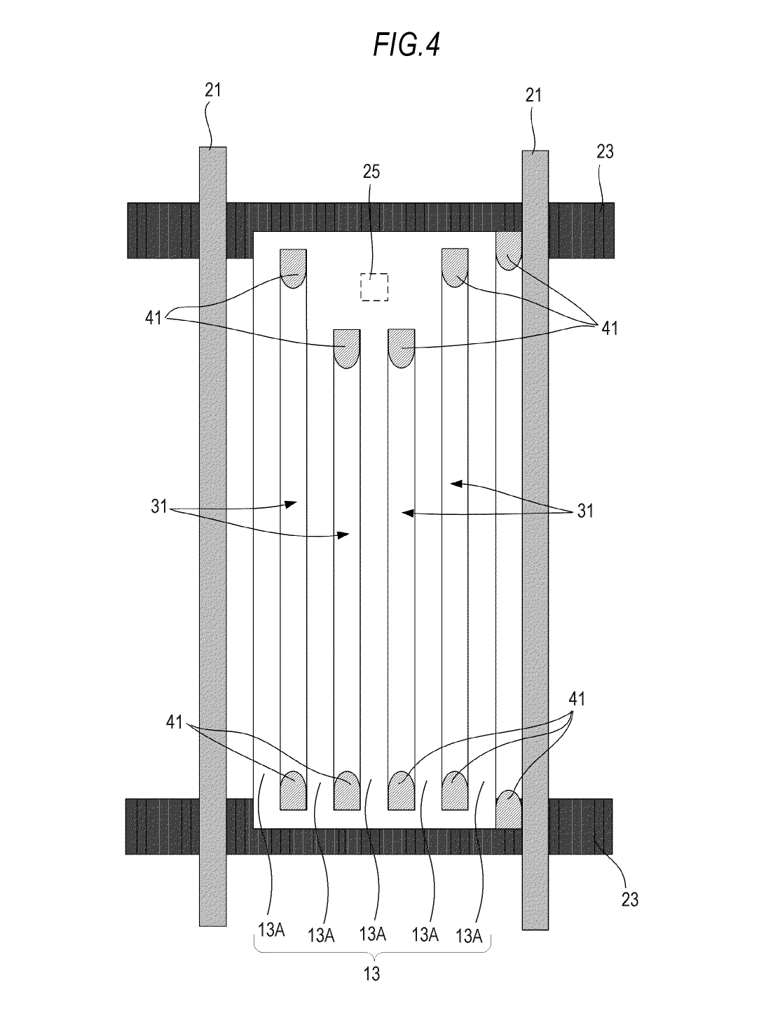

FIG. 5 is a diagram illustrating a reverse twist phenomenon.

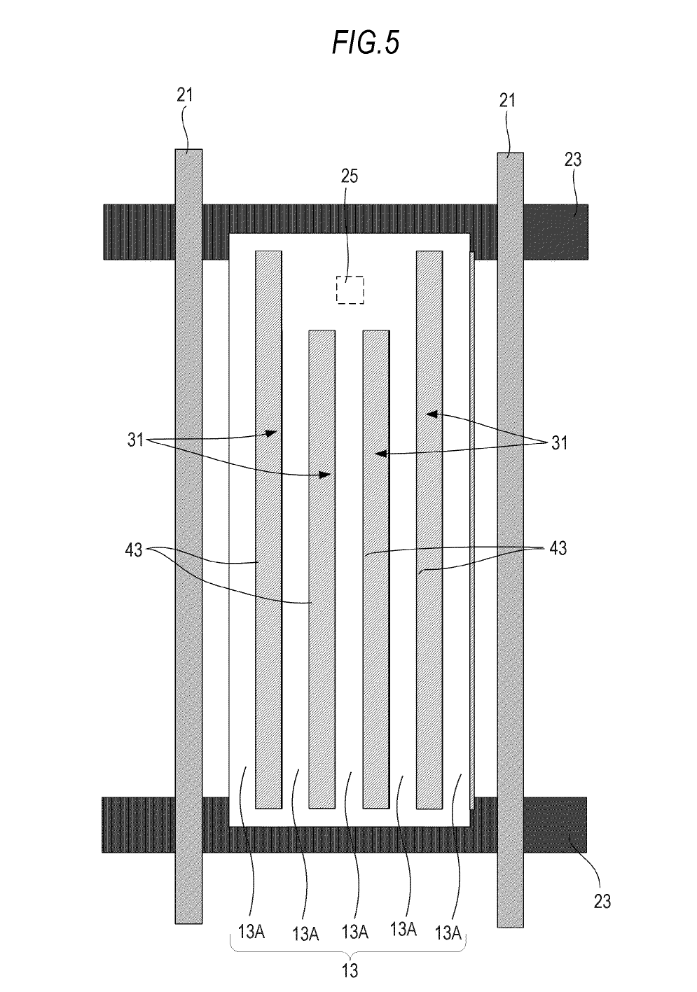

FIG. 6 is a diagram showing an appearance example of a liquid crystal panel module.

FIG. 7 is a diagram showing an example of the system configuration of a liquid crystal panel module.

FIG. 8 is a diagram illustrating the cross angle between the extension direction of each slit and the alignment direction of a liquid crystal layer.

FIG. 9 is a diagram illustrating the relationship between the magnitude of a cross angle and display irregularity disappearance time.

FIG. 10 is a diagram illustrating the relationship between the magnitude of a cross angle and the level of display irregularity.

FIG. 11 is a diagram illustrating the relationship between the magnitude of a cross angle and relative transmittance.

FIG. 12 is a diagram showing a first pixel structure example (planar structure).

FIG. 13 is a diagram showing a second pixel structure example (planar structure).

FIG. 14 is a diagram showing a third pixel structure example (planar structure).

FIG. 15 is a diagram showing a fourth pixel structure example (planar structure).

FIG. 16 is a diagram showing a fifth pixel structure example (sectional structure).

FIG. 17 is a diagram showing a sixth pixel structure example (sectional structure).

FIG. 18 is a diagram showing a sixth pixel structure example (planar structure).

FIG. 19 is a diagram showing a seventh pixel structure example (planar structure).

FIG. 20 is a diagram illustrating the system configuration of an electronic apparatus.

FIG. 21 is a diagram showing an appearance example of an electronic apparatus.

FIGS. 22A and 22B are diagrams showing an appearance example of an electronic apparatus.

FIG. 23 is a diagram showing an appearance example of an electronic apparatus.

FIGS. 24A and 24B are diagrams showing an appearance example of an electronic apparatus.

FIG. 25 is a diagram showing an appearance example of an electronic apparatus

### DETAILED DESCRIPTION

The present application will be described below with reference to the figures according to an embodiment.

(A) Appearance Example of Liquid Crystal Panel Module and Panel Structure

(B) Characteristics Found between Extension Direction of Slit and Alignment Direction of Liquid Crystal Layer

(C) Pixel Structure Example 1

(D) Pixel Structure Example 2

(E) Pixel Structure Example 3

(F) Pixel Structure Example 4

(G) Pixel Structure Example 5

(H) Pixel Structure Example 6

(I) Pixel Structure Example 7

(J) Other Examples

Elements which are not provided with particular drawings or descriptions herein are realized by existing techniques in the relevant technical field. Embodiments described below are exemplary, and not limiting to the present application.

### (A) Appearance Example of Liquid Crystal Panel Module and Panel Structure

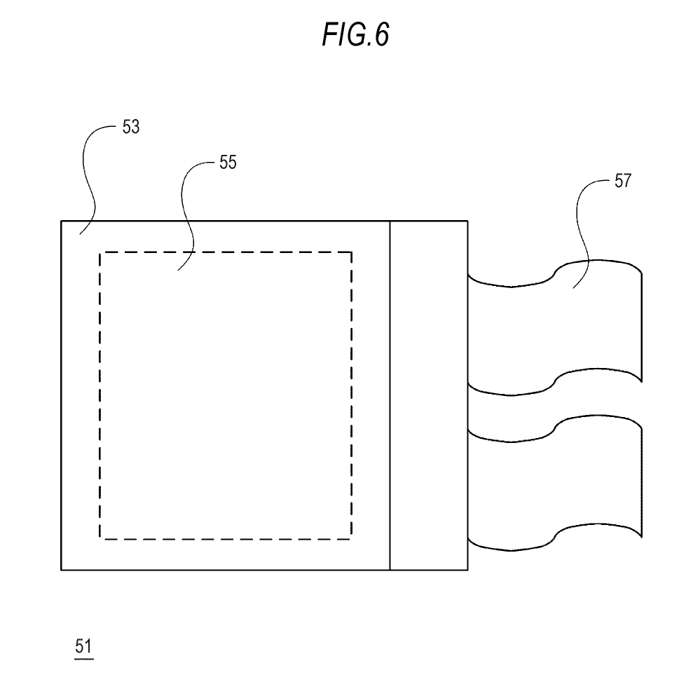

FIG. 6 shows an appearance example of a liquid crystal panel module 51. The liquid crystal panel module 51 is structured such that a counter substrate 55 is bonded to a support substrate 53. The support substrate 53 is made of glass, plastic, or other substrates. The counter substrate 55 is also made of glass, plastic, or other transparent substrates. The counter substrate 55 is a member which seals the surface of the support substrate 53 with a sealant interposed therebetween.

Note that only one substrate on the light emission side may be a transparent substrate, and the other substrate may be a nontransparent substrate.

The liquid crystal panel 51 is provided with an FPC (Flexible Printed Circuit) 57 for inputting an external signal or driving power, if necessary.

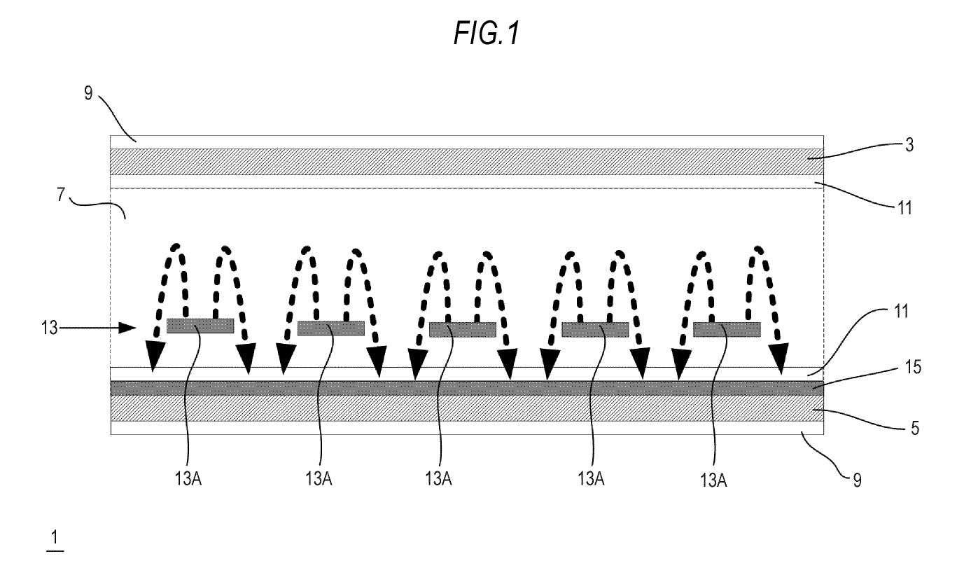

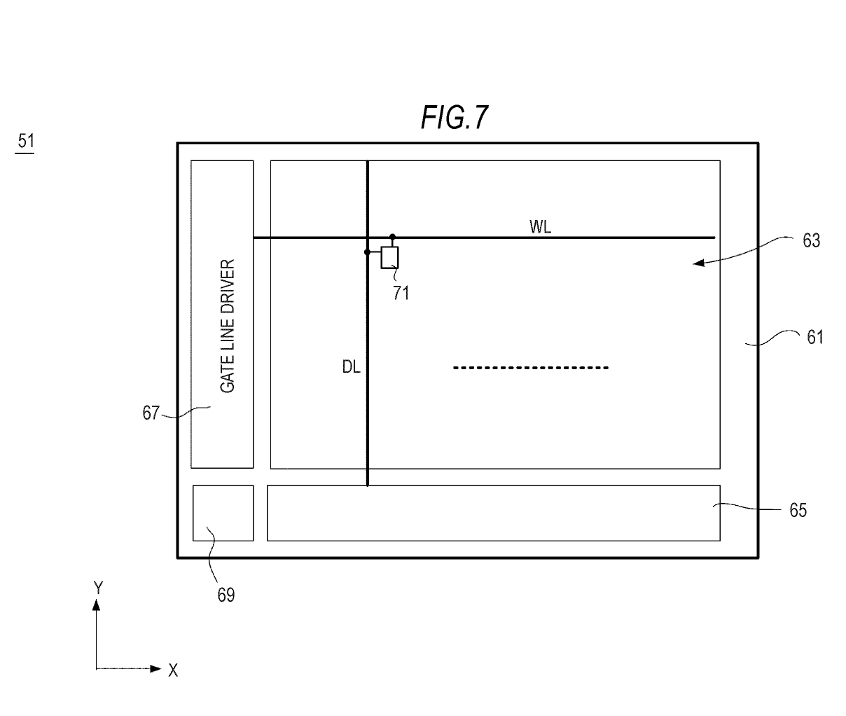

FIG. 7 shows an example of the system configuration of the liquid crystal panel module 51. The liquid crystal panel module 51 is configured such that a pixel array section 63, a signal line driver 65, a gate line driver 67, and a timing controller 69 are disposed on a lower glass substrate 61 (corresponding to the glass substrate 5 of FIG. 1). In this embodiment, the driving circuit of the pixel array section 63 is formed as a single or a plurality of semiconductor integrated circuits, and is mounted on the glass substrate.

The pixel array section 63 has a matrix structure in which white units each constituting one pixel for display are arranged in M rows×N columns. In this specification, the row refers to a pixel row of 3×N subpixels 71 arranged in the X direction of the drawing. The column refers to a pixel column of M subpixels 71 arranged in the Y direction of the drawing. Of course, the values M and N are determined depending on the display resolution in the vertical direction and the display resolution in the horizontal direction.

The signal line driver 65 is used to apply a signal potential Vsig corresponding to a pixel gradation value to signal lines DL. In this embodiment, the signal lines DL are arranged so as to extend in the Y direction of the drawing.

The gate line driver 67 is used to apply control pulses for providing the write timing of the signal potential Vsig to scanning lines WL. In this embodiment, the scanning lines WL are arranged so as to extend in the X direction of the drawing.

A thin film transistor (not shown) is formed in each subpixel 71. The thin film transistor has a gate electrode connected to a corresponding one of the scanning lines WL, one main electrode connected to a corresponding one of the signal lines DL, and the other main electrode connected to the pixel electrode 13.

The timing controller 69 is a circuit device which supplies driving pulses to the signal line driver 65 and the gate line driver 67.

### (B) Characteristics Found between Extension Direction of Slit and Alignment Direction of Liquid Crystal Layer

As described above, in the existing pixel structure, if disturbance (reverse twist phenomenon) of the alignment of liquid crystal molecules occurs due to finger press or the like, the disturbance is continuously viewed as display irregularity.

Accordingly, the inventors have experimented on whether the disturbance of the alignment of liquid crystal molecules can be reduced or not by itself by changing the cross angle between the extension direction of each slit 31 formed by the electrode branches 13A of the pixel electrode 13 and the alignment direction of the liquid crystal layer 7. The alignment direction of the liquid crystal layer 7 (also referred to as “alignment direction of liquid crystal”) is defined by the orientation of dielectric anisotropy of liquid crystal, and refers to a direction with a large dielectric constant.

Hereinafter, the characteristics which become clear experimentally will be described.

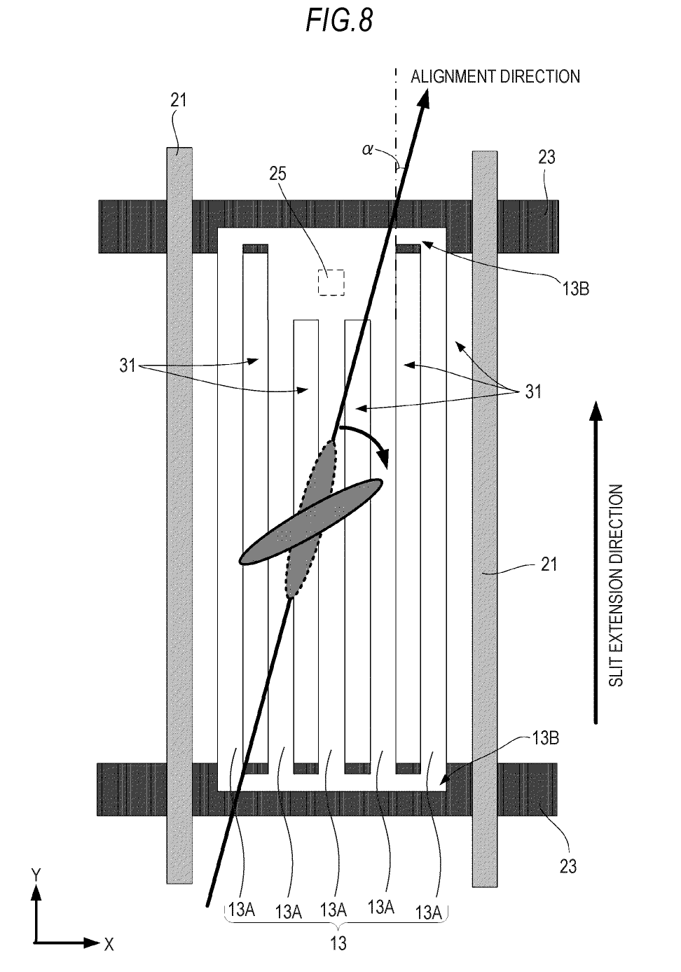

First, the relationship between the slit 31 and the alignment direction of the liquid crystal layer 7 will be described with reference to FIG. 8. FIG. 8 is a diagram showing the planar structure of the subpixel 71. In FIG. 8, the relationship between the extension direction of the slit 31 and the alignment direction of the liquid crystal layer 7 is focused on. For this reason, a thin film transistor and the like are not shown.

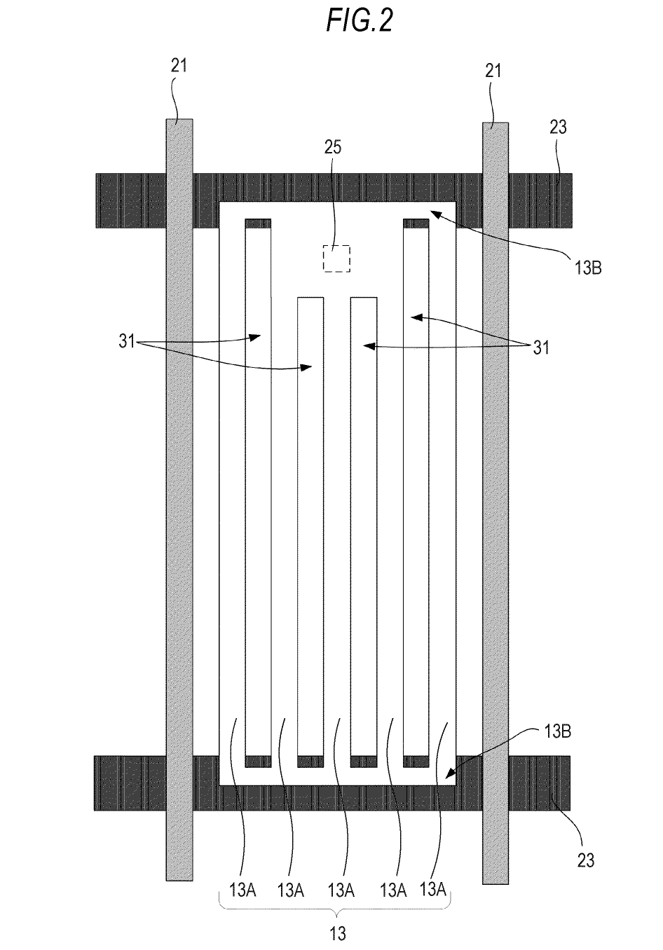

The planar structure of FIG. 8 is identical to the planar structure described with reference to FIG. 2, and the corresponding elements are represented by the same reference numerals. That is, the subpixel 71 is formed in a rectangular region surrounded by the signal lines 21 extending in the Y direction and the scanning lines 23 extending in the X direction. The pixel electrode 13 has five electrode branches 13A and connection portions 13B respectively connecting both ends of the electrode branches 13A. In FIG. 8, the slits 31 formed between the electrode branches 13A or the slit 31 formed between the electrode branches 13A and the signal line 21 on the right side in the drawing extend in the Y direction.

That is, the extension direction of each slit 31 is parallel to the signal line 21 and perpendicular to the scanning line 23.

In FIG. 8, the alignment direction of the liquid crystal layer 7 is indicated by an arrow. In FIG. 8, the oblique upper right direction with respect to the paper is the alignment direction of the liquid crystal layer 7. In FIG. 8, the cross angle between the alignment direction of the liquid crystal layer 7 and the extension direction of each slit 31 is indicated by α.

The inventors have focused on the cross angle α, and have measured the time until display irregularity disappears with respect to various cross angles α.

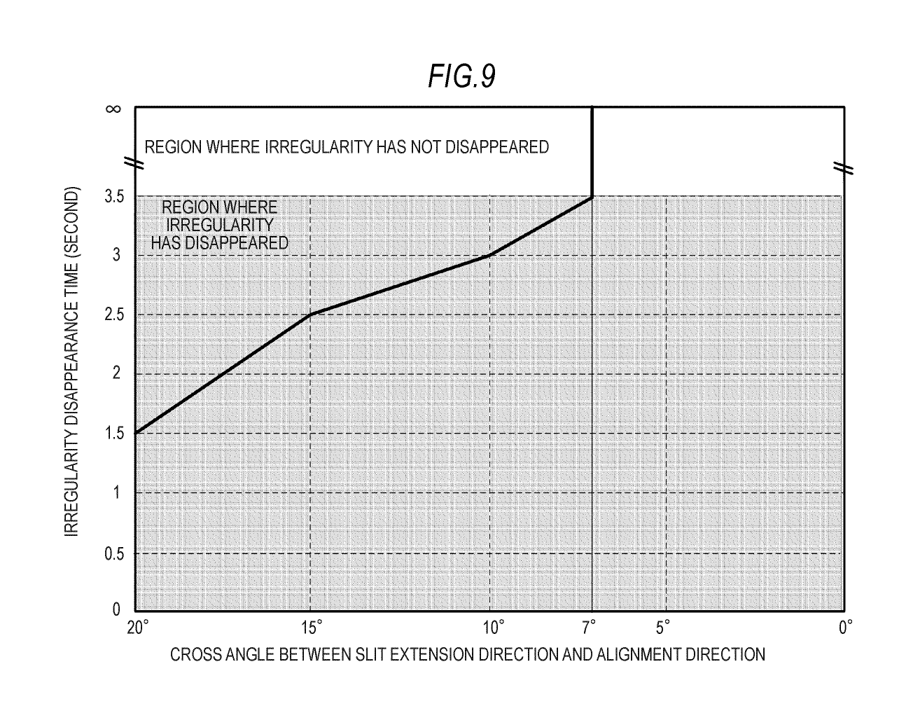

FIG. 9 shows the measurement result. In FIG. 9, the horizontal axis represents the cross angle α between the extension direction of each slit 31 and the alignment direction of the liquid crystal layer 7, and the vertical axis represents the time until display irregularity disappears.

From the experiment result of FIG. 9, it has been confirmed that, when the cross angle α is smaller than 7°, display irregularity due to the reverse twist phenomenon does not disappear by itself.

Meanwhile, when the cross angle α is equal to or larger than 7°, it has been confirmed that display irregularity due to the reverse twist phenomenon can disappear by itself. When the cross angle α is 7°, the time until display irregularity disappears is 3.5 [seconds]. Further, from the experiment result, it has been confirmed that, as the cross angle α becomes larger, the time until display irregularity disappears is shortened. For example, when the cross angle α is 10°, it has been confirmed that display irregularity disappears in 3 [seconds]. When the cross angle α is 15°, it has been confirmed that display irregularity disappears in 2.5 [seconds]. When the cross angle α is 20°, it has been confirmed that display irregularity disappears in 1.5 [seconds].

As a result, the inventors have found that, if the cross angle α between the extension direction of each slit 31 and the alignment direction of the liquid crystal layer 7 is set to be equal to or larger than 7°, in the transverse electric field display type liquid crystal panel, the alignment stability of liquid crystal molecules when a voltage is applied can be improved. That is, it has been found that, even though the reverse twist phenomenon occurs due to finger press or the like, the disturbance of the alignment can disappear by itself.

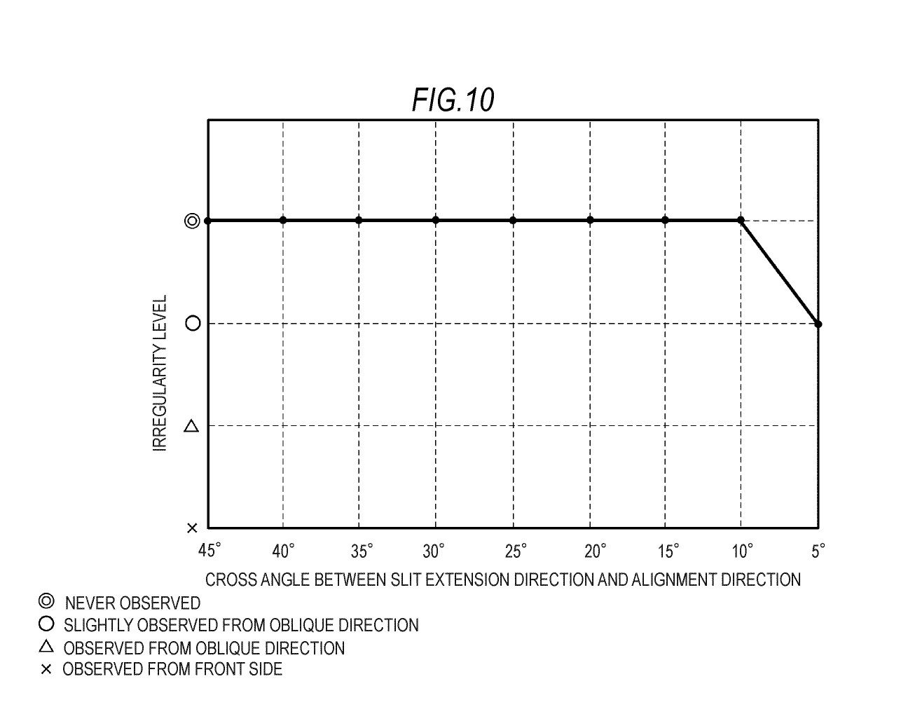

FIG. 10 shows the observation result regarding the relationship between the cross angle α and the level of display irregularity. In FIG. 10, the horizontal axis denotes the cross angle α between the extension direction of the slit 31 and the alignment direction of the liquid crystal layer 7, and the vertical axis denotes the visible level of display irregularity.

As shown in FIG. 10, if the cross angle α is equal to or larger than 10°, it has been confirmed that no display irregularity is observed even when the display screen is viewed at any angle. When the cross angle α is 5°, it has been confirmed that, when the display screen is viewed from an oblique direction, slight display irregularity is observed. When the cross angle α is equal to or larger than 5° and smaller than 10°, as shown in FIG. 10, it has been confirmed that visibility is gradually changed.

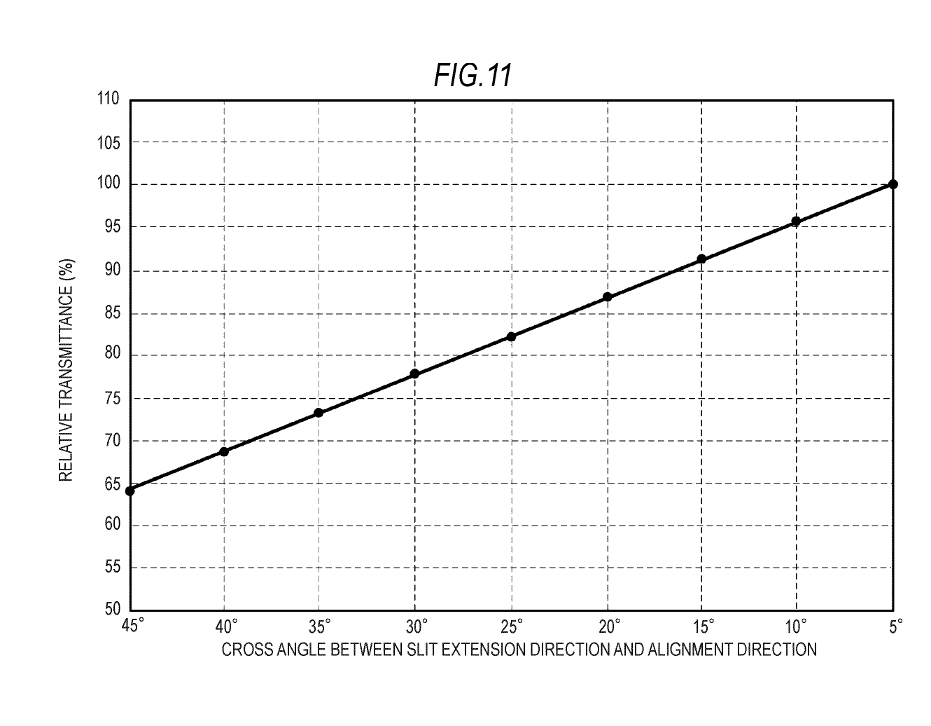

However, it has been confirmed that, if the cross angle α is extremely large, the transmittance is lowered. FIG. 11 shows the confirmed transmission characteristics. In FIG. 11, the horizontal axis denotes the cross angle α between the extension direction of the slit 31 and the alignment direction of the liquid crystal layer 7, and the vertical axis denotes relative transmittance. In FIG. 11, it is assumed that, when the cross angle α is 5°, the relative transmittance is 100%.

In FIG. 11, when the cross angle α is 5°, the maximum transmittance is obtained, and when the cross angle α is 45°, the minimum transmittance is obtained. Note that, when the cross α is 45°, the relative transmittance is about 64%.

As shown in FIG. 11, it has been seen that the cross angle α and the relative transmittance have a roughly linear relationship. From the viewpoint of transmittance, it can be seen that, as the cross angle α is smaller, better display luminance is obtained.

From the above-described characteristics, the inventors have considered it preferable that the cross angle α between the extension direction of the slit 31 and the alignment direction of the liquid crystal layer 7 be equal to or larger than 7°.

Meanwhile, taking good relative transmittance and good display irregularity disappearance time into consideration, the inventors have considered it preferable that the cross angle α be equal to or larger than 7° and equal to or smaller than 15°.

### (C) Pixel Structure Example 1

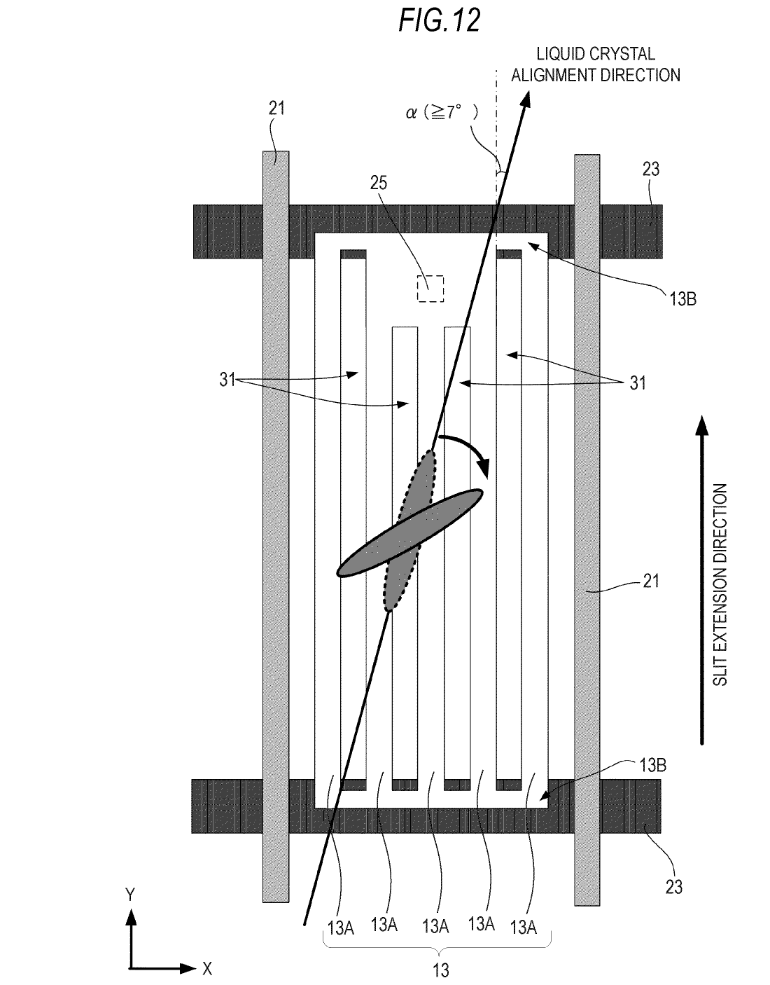

The pixel structure shown in FIG. 12 is identical to the pixel structure described with reference to FIG. 8 and is used in an FFS (Fringe Field Switching) type liquid crystal panel. Thus, the sectional structure of the pixel region is the same as shown in FIG. 1. That is, the counter electrode 15 is disposed below the pixel electrode 13 so as to cover the entire pixel region.

As shown in FIG. 12, the cross angle α between the alignment direction of the liquid crystal layer 7 and the extension direction of the slit 31 is set so as to be equal to or larger than 7°.

With this pixel structure, the liquid crystal molecules which are located above the pixel electrode 13 can also be moved by a parabolic electric field formed between the pixel electrode 13 and the counter electrode 15. Specifically, in FIG. 12, the liquid crystal molecules can be moved in the clockwise direction. For this reason, a liquid crystal panel with a wide viewing angle can be realized. Further, as described above, the alignment direction of the liquid crystal layer 7 is optimized with respect to the extension direction of the slit 31. Therefore, even though the arrangement of the liquid crystal molecules is disturbed due to the reverse twist phenomenon caused by finger press or the like, the arrangement disturbance can be eliminated by itself in several seconds.

### (D) Pixel Structure Example 2

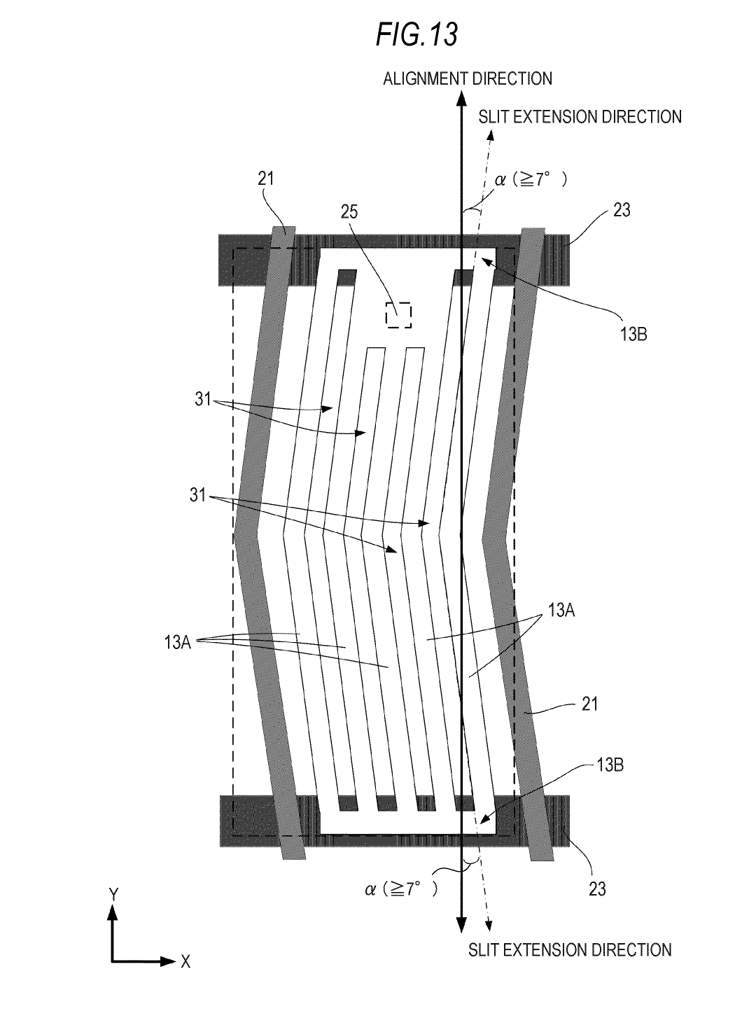

FIG. 13 shows a second pixel structure example. This pixel structure is also identical to the pixel structure described with reference to FIG. 12 and used in an FFS (Fringe Field Switching) type liquid crystal panel.

Meanwhile, the second pixel structure is configured such that the pixel electrode 13 is bent around the center of the pixel region (in the drawing, a rectangular region indicated by a broken line). In FIG. 13, one bend point is provided.

The pixel structure shown in FIG. 13 is a vertical mirror structure along a virtual line extending from the bend point in the X-axis direction.

Under this condition, the alignment direction of the liquid crystal layer 7 crosses the extension direction of the slit 31 at an angle of 7° or larger. In FIG. 13, focusing on that the pixel electrode 13 has a vertical mirror structure along the virtual line extending in the X-axis direction, the alignment direction of the liquid crystal layer 7 is set so as to be parallel to the Y-axis direction.

Therefore, in FIG. 13, the electrode branches 13A are formed such that the cross angle α between each electrode branch 13A and the Y-axis direction is equal to or larger than 7°. Preferably, the cross angle α between each electrode branch 13A and the Y-axis direction is equal to or larger than 7° and equal to or smaller than 15°. This is because, if the cross angle α is equal to or larger than 15°, the relative transmittance is somewhat lowered.

In the case of the pixel structure with a dual domain structure, the rotation direction of the liquid crystal molecules is inverted between the upper half portion and the lower half portion of the pixel region during voltage application. That is, while the liquid crystal molecules in the upper half portion of the pixel region in the drawing rotate in the counterclockwise direction by the application of an electric field, the liquid crystal molecules in the lower half portion of the pixel region in the drawing rotate in the clockwise direction by the application of an electric field.

In this way, the rotation direction of the liquid crystal molecules is inverted, so the amount of light per pixel can be made uniform even when the display screen is viewed at any angle. Therefore, a liquid crystal panel with a wider viewing angle than the pixel structure described with reference to FIG. 12 can be realized. Of course, as described above, the relationship between the alignment direction of the liquid crystal layer 7 and the extension direction of the slit 31 is optimized, so even though the arrangement of the liquid crystal molecules is disturbed due to the reverse twist phenomenon caused by finger press or the like, the arrangement disturbance can be eliminated by itself in several seconds.

### (E) Pixel Structure Example 3

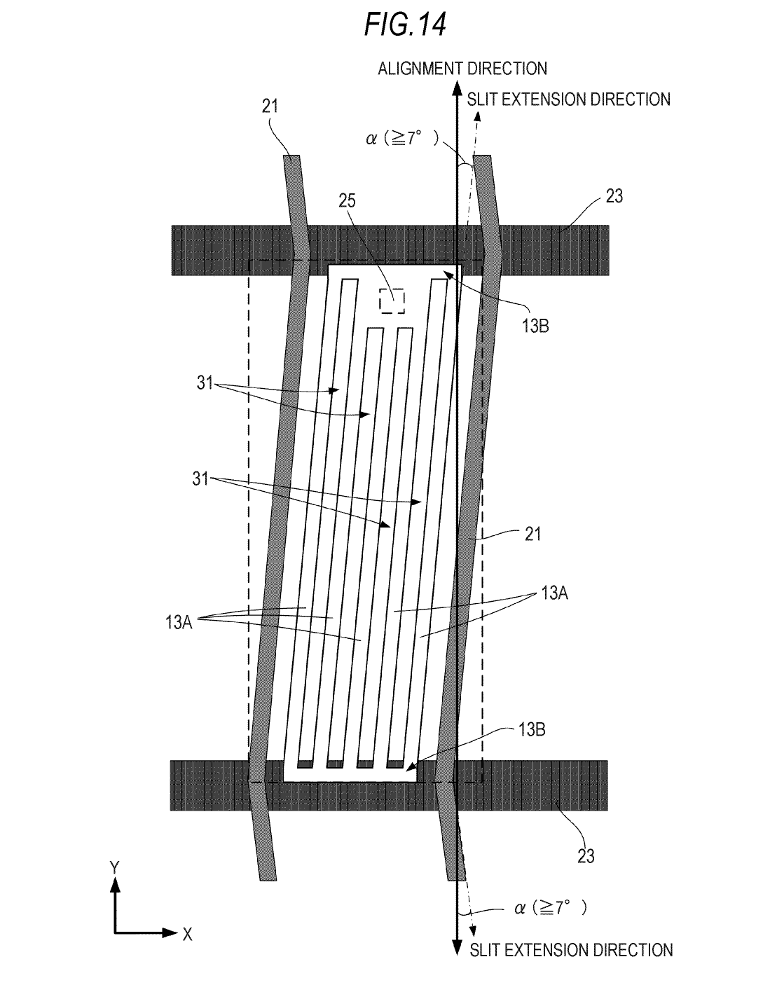

FIG. 14 shows a third pixel structure example. This pixel structure also corresponds to a pixel structure for an FFS (Fringe Field Switching) type liquid crystal panel.

While the pixel structure shown in FIG. 13 has in one pixel two regions where the rotation direction of the liquid crystal molecules differs, in this pixel structure example, the rotation direction of the liquid crystal molecules differs between two pixel regions arranged in the vertical direction.

FIG. 14 shows the entire pixel region where the liquid crystal molecules rotate in the counterclockwise direction during the application of an electric field. Thus, a pixel region where the liquid crystal molecules rotate in the clockwise direction during the application of an electric field is disposed above and below the pixel region shown in FIG. 14. FIG. 14 shows a partial pattern of the signal line 21 of the relevant pixel region.

The pixel structure shown in FIG. 14 is a vertical mirror structure from the scanning line 23 located between the two pixel regions arranged in the vertical direction.

In FIG. 14, in all the pixel regions, the alignment direction of the liquid crystal layer 7 is parallel to the Y-axis direction. If the condition that the cross angle between the alignment direction of the liquid crystal layer 7 (Y-axis direction) and the extension direction of the slit 31 is equal to or larger than 7° is satisfied, the alignment direction of the liquid crystal layer 7 may differ between the pixel regions.

Therefore, in FIG. 14, the electrode branches 13A are formed such that the cross angle α between each electrode branch 13A and the Y-axis direction is equal to or larger than 7°. Preferably, the cross angle α between each electrode branch 13A and the Y-axis direction is equal to or larger than 7° and equal to or smaller than 15°. This is because, if the cross angle α is equal to or larger than 15°, the relative transmittance is somewhat lowered.

In this pixel structure, the rotation direction of the liquid crystal molecules is inverted between adjacent pixel regions in the vertical direction. That is, while the liquid crystal molecules in one region rotate in the clockwise direction by the application of an electric field, the liquid crystal molecules in the other pixel region rotate in the counterclockwise direction by the application of an electric field.

In this way, the rotation direction of the liquid crystal molecules is inverted between the two upper and lower pixel regions, so a liquid crystal panel with a wide viewing angle can be realized. Of course, as described above, the relationship between the alignment direction of the liquid crystal layer 7 and the extension direction of the slit 31 is optimized, so even though the arrangement of the liquid crystal molecules is disturbed due to the reverse twist phenomenon caused by finger press or the like, the arrangement disturbance can be eliminated by itself in several seconds.

### (F) Pixel Structure Example 4

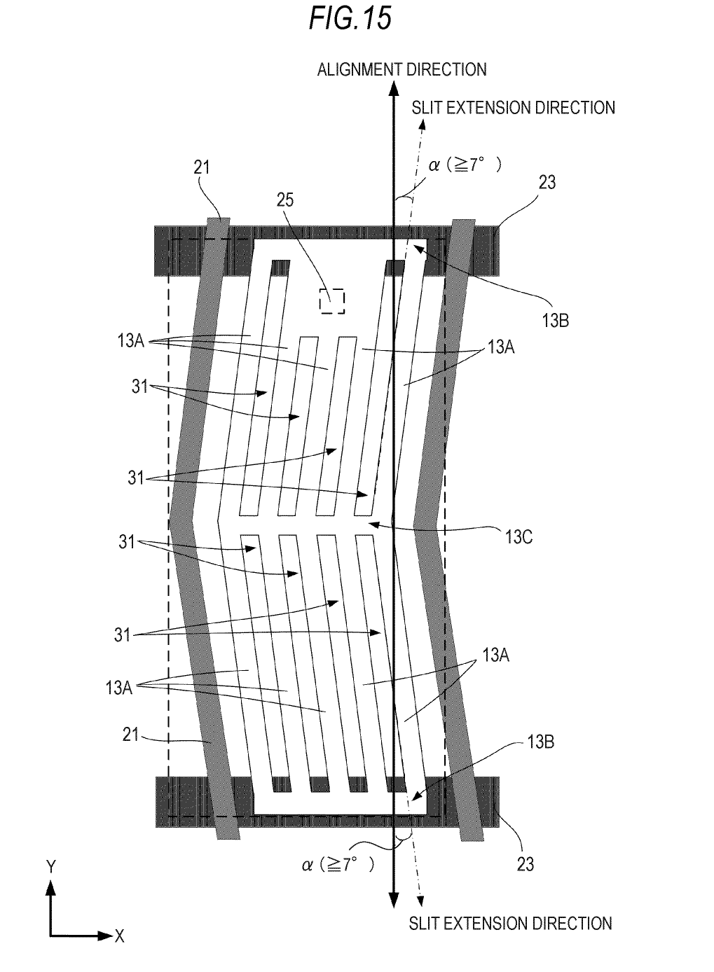

FIG. 15 shows a fourth pixel structure example. This pixel structure corresponds to a modification of the pixel structure shown in FIG. 13. That is, the pixel structure shown in FIG. 15 corresponds to a pixel structure in which one pixel has two regions where the rotation direction of the liquid crystal molecules differs. Therefore, the basic pixel structure is identical to the pixel structure shown in FIG. 13.

A difference is that a connection branch 13C connecting the bend points of the electrode branches 13A to each other is further used.

In the pixel structure of FIG. 13, the rotation direction of the liquid crystal molecules is inverted at the boundary between the domains. For this reason, alignment disturbance inevitably occurs at the boundary, which may adversely affect the disappearance of the reverse twist line phenomenon.

Meanwhile, in the pixel structure of FIG. 14, the two domains can be completely separated from each other by the connection branch 13C. For this reason, it is possible to reduce the arrangement disturbance of the liquid crystal molecules during voltage application at the boundary between the domains. As a result, with the pixel structure shown in FIG. 14, the time until the reverse twist line disappears can be further shortened, as compared with the pixel structure shown in FIG. 13.

### (G) Pixel Structure Example 5

In the above-described four pixel structure examples, an FFS type liquid crystal panel having the sectional structure described with reference to FIG. 1 has been described. That is, a liquid crystal panel has been described which has the pixel structure in which the counter electrode 15 is disposed below the comb-shaped pixel electrode 13 so as to cover the entire pixel region.

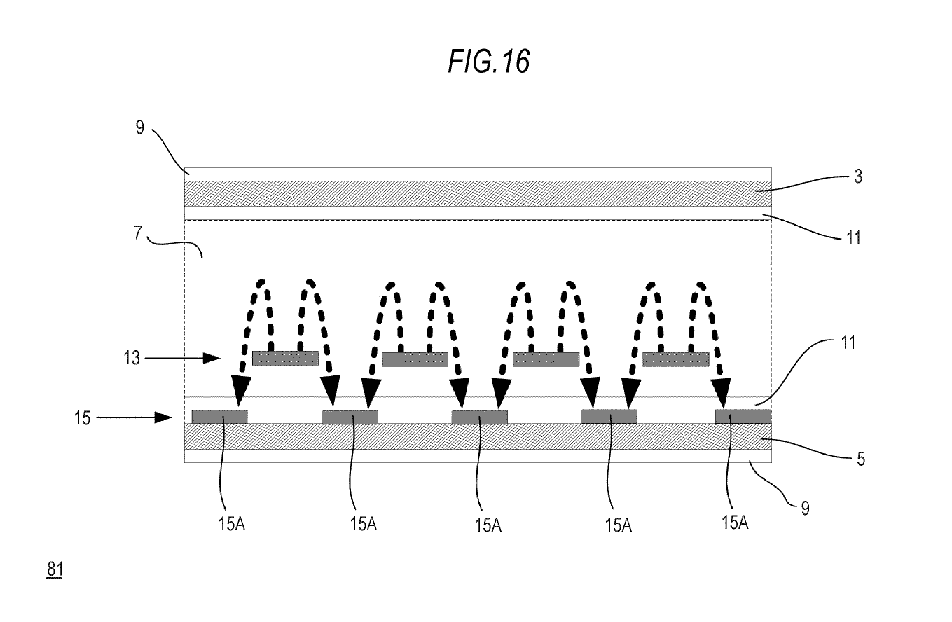

Alternatively, as shown in FIG. 16, a liquid crystal panel may be used in which the counter electrode 15 is formed in a comb shape. In FIG. 16, the electrode branches 15A of the counter electrode 15 are disposed so as to fill the spaces (slits 31) between the electrode branches 13A of the pixel electrode 13. That is, the electrode branches 15A of the counter electrode 15 are disposed so as not to overlap the electrode branches 13A of the pixel electrode 13 in the pixel region.

### (H) Pixel Structure Example 6

In the above-described pixel structure examples, the description has been made of the pixel structure in which the pixel electrode 13 and the counter electrode 15 are formed in different layers.

Alternatively, the technique which has been suggested by the inventors may be applied to a transverse electric field display type liquid crystal panel in which the pixel electrode 13 and the counter electrode 15 are formed in the same layer.

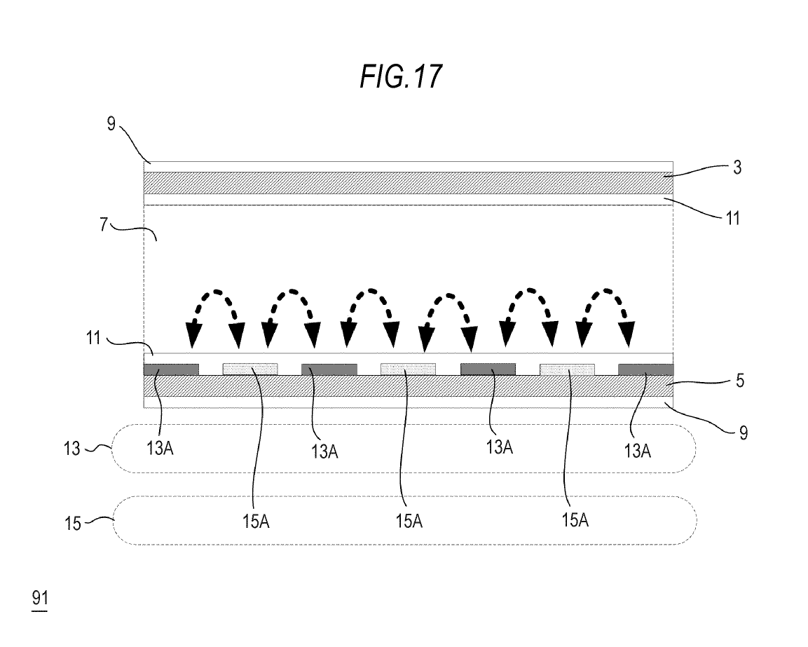

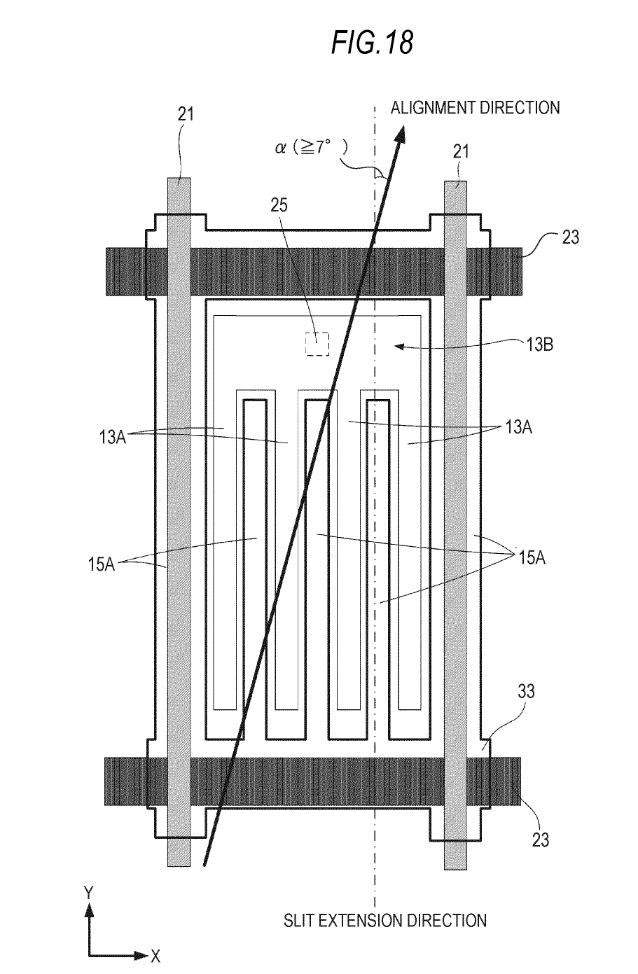

FIG. 17 shows a sectional structure example corresponding to a sixth pixel structure example. FIG. 18 shows a planar structure example corresponding to the sixth pixel structure example. The structure excluding the pixel structure 13 and the counter electrode 15 is basically the same as the pixel structure described with reference to FIGS. 1 and 2.

That is, a liquid crystal panel 91 includes two glass substrates 3 and 5, and a liquid crystal layer 7 filled so as to be sandwiched with the glass substrates 3 and 5. A polarizing plate 9 is disposed on the outer surface of each substrate, and an alignment film 11 is disposed on the inner surface of each substrate.

In FIG. 17, the pixel electrode 13 and the counter electrode 15 are formed on the glass substrate 5. Of these, the pixel electrode 13 is structured such that one ends of comb-shaped four electrode branches 13A are connected to each other by a connection portion 13B. Meanwhile, the counter electrode 15 is structured such that one ends of comb-shaped three electrode branches 15A are connected to a common electrode line 33. In this case, the electrode branches 15A of the counter electrode 15 are disposed so as to be fitted into the spaces between the electrode branches 13A of the pixel electrode 13. The common electrode line 33 is formed in a lattice shape so as to follow the signal lines 21 and the scanning lines 23.

For this electrode structure, as shown in FIG. 17, the electrode branches 13A of the pixel electrode 13 and the electrode branches 15A of the counter electrode 15 are alternately disposed in the same layer. With this electrode structure, a parabolic electric field is generated between the electrode branches 13A of the pixel electrode 13 and the electrode branches 15A of the counter electrode 15. In FIG. 17, this electric field is indicated by a broken line.

FIG. 18 shows a case where the extension direction of each slit formed by the electrode branches 13A of the pixel electrode 13 is parallel to the signal line 21. Of course, as shown in FIG. 18, the cross angle α between the alignment direction of the liquid crystal layer 7 and the extension direction of each slit 31 is set so as to be equal to or larger than 7°.

With this pixel structure, a liquid crystal panel can be realized in which, even though the arrangement of the liquid crystal molecules is disturbed due to the reverse twist phenomenon caused by finger press or the like, the arrangement disturbance can be eliminated by itself in several seconds. Of course, a wide viewing angle according to a transverse electric field can be realized.

### (I) Pixel Structure Example 7

In the above-described six pixel structure examples, a case has been described where the extension direction of each slit 31 formed by the electrode branches 13A of the pixel electrode 13 is parallel to the signal line 21 or cross obliquely with respect to the signal line 21.

Alternatively, the extension direction of each slit 31 formed by the electrode branches 13A of the pixel electrode 13 may be parallel to the scanning line 23 or may cross obliquely with respect to the scanning line 23.

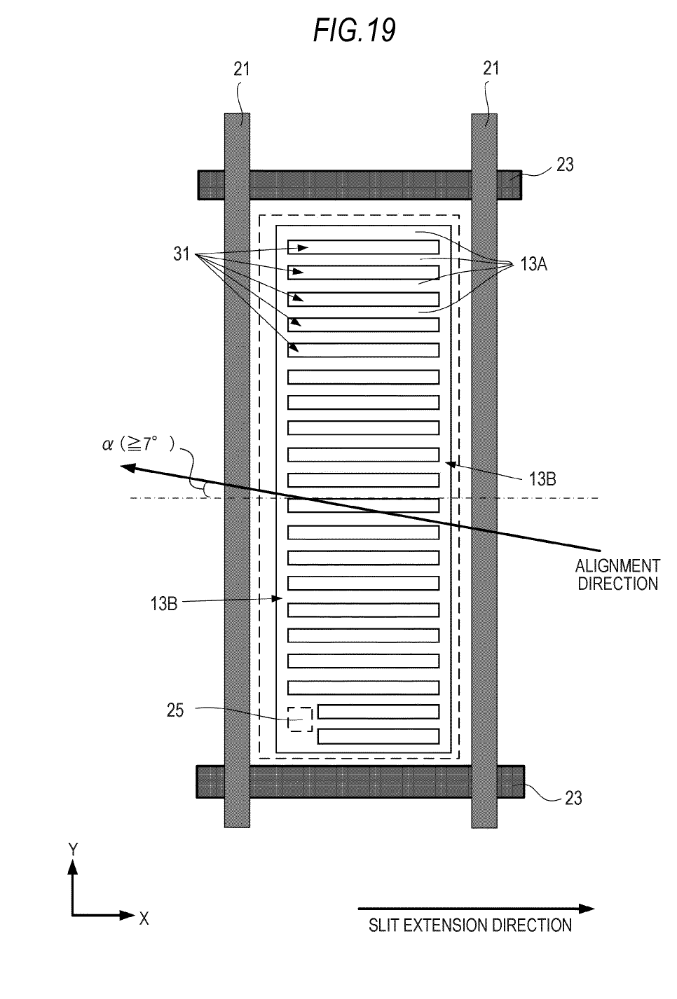

FIG. 19 shows an example of such a pixel structure. FIG. 19 shows a pixel structure example where the pixel electrode 13 and the counter electrode 15 are disposed in different layers on the glass substrate 5. Of course, the same pixel structure as the sixth pixel structure example is taken into consideration.

Returning to FIG. 19, the electrode branches 13A of the pixel electrode 13 are formed so as to be parallel to the scanning line 23. Both ends of the electrode branches 13A are connected by connection portions 13B. For this reason, each slit 31 formed between the electrode branches 13A extends in the X direction.

In this pixel structure, when external pressure, such as finger press or the like, is applied to the liquid crystal layer 7, the reverse twist phenomenon inevitably occurs along the slit 31. However, as described above, if the cross angle α between the alignment direction of the liquid crystal layer 7 and the extension direction of the slit 31 is set equal to or larger than 7°, the reverse twist phenomenon can disappear by itself in several seconds.

In FIG. 19, an example of the optimum alignment direction is indicated by a bold arrow.

### (J) Other Examples

### (J-1) Substrate Material

In the above description of the examples, the substrate is a glass substrate, but a plastic substrate or other substrates may be used.

### (J-2) Product Examples

In the above description, various pixel structures capable of generating a transverse electric field have been described. Hereinafter, description will be provided for electronic apparatuses in which a liquid crystal panel having the pixel structure according to the examples (with no driving circuit mounted therein) or a liquid crystal panel module (with a driving circuit mounted therein) is mounted.

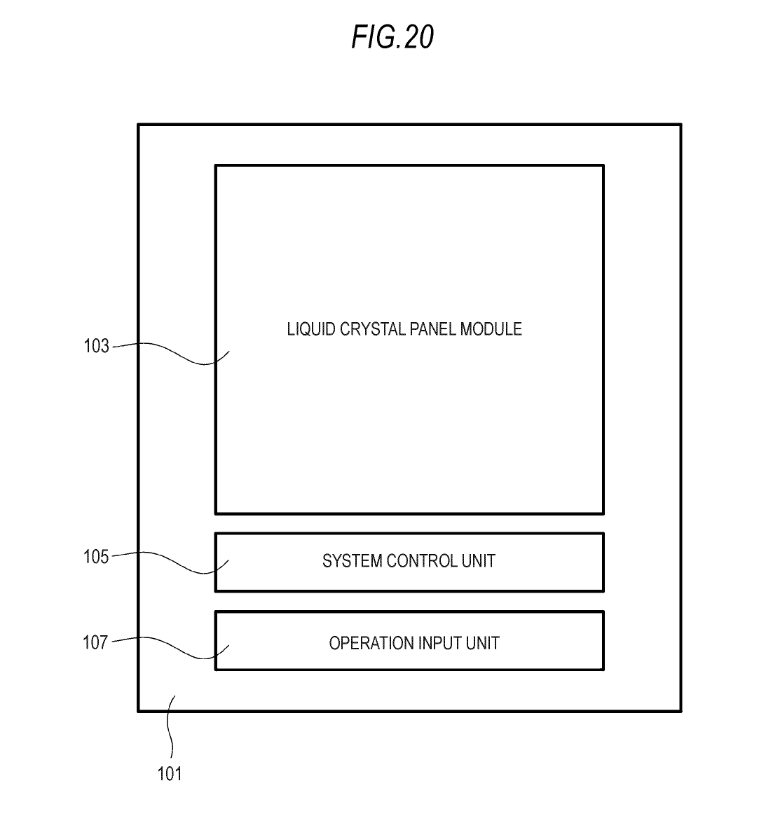

FIG. 20 shows a conceptual example of the configuration of an electronic apparatus 101. The electronic apparatus 101 includes a liquid crystal panel 103 having the above-described pixel structure, a system control unit 105, and an operation input unit 107. The nature of processing performed by the system control unit 105 varies depending on the product type of the electronic apparatus 101.

The configuration of the operation input unit 107 varies depending on the product type. A GUI (Graphic User Interface), switches, buttons, a pointing device, and other operators may be used as the operation input unit 107.

It should be noted that the electronic apparatus 101 is not limited to an apparatus designed for use in a specific field insofar as it can display an image or video generated inside or input from the outside.

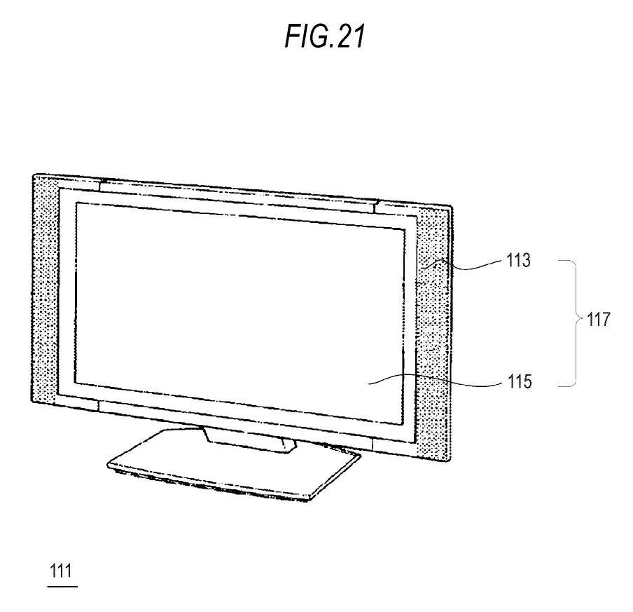

FIG. 21 shows an appearance example of a television receiver as an electronic apparatus. A television receiver 111 has a display screen 117 on the front surface of its housing. The display screen 117 includes a front panel 113, a filter glass 115, and the like. The display screen 117 corresponds to the liquid crystal panel according to the embodiment.

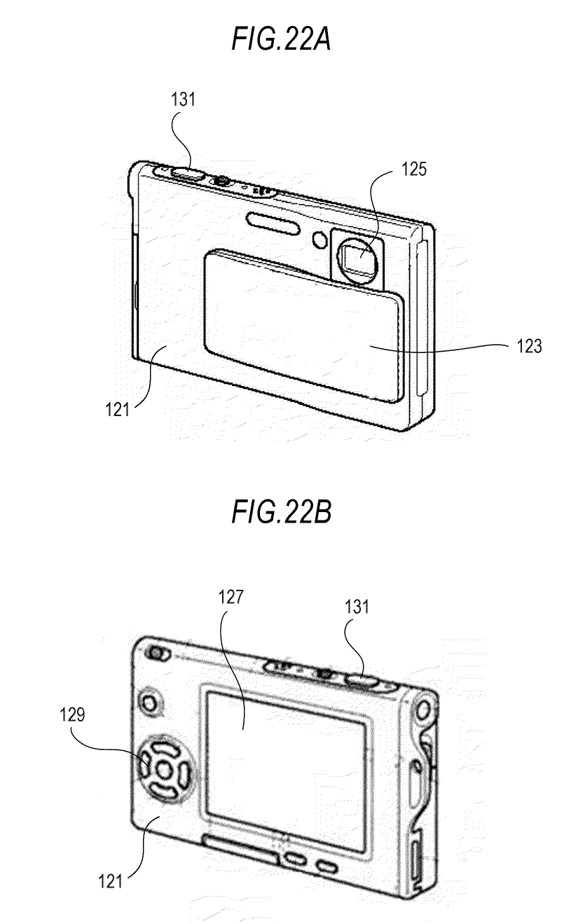

The electronic apparatus 101 may be, for example, a digital camera. FIGS. 22A and 22B show an appearance example of a digital camera 121. FIG. 22A shows an appearance example as viewed from the front (from the subject), and FIG. 22B shows an appearance example when viewed from the rear (from the photographer).

The digital camera 121 includes a protective cover 123, an imaging lens section 125, a display screen 127, a control switch 129, and a shutter button 131. Of these, the display screen 127 corresponds to the liquid crystal panel according to the embodiment.

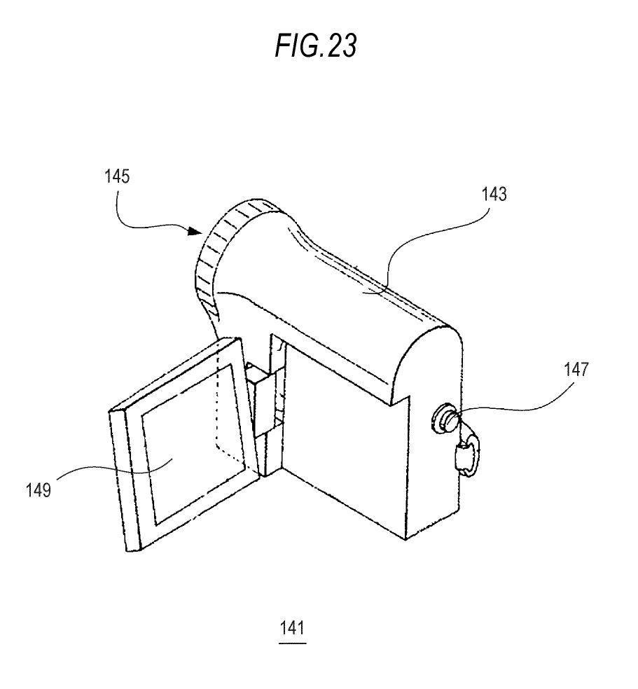

The electronic apparatus 101 may be, for example, a video camcorder. FIG. 23 shows an appearance example of a video camcorder 141.

The video camcorder 141 includes an imaging lens 145 provided to the front of a main body 143 so as to capture the image of the subject, a photographing start/stop switch 147, and a display screen 149. Of these, the display screen 149 corresponds to the liquid crystal panel according to the embodiment.

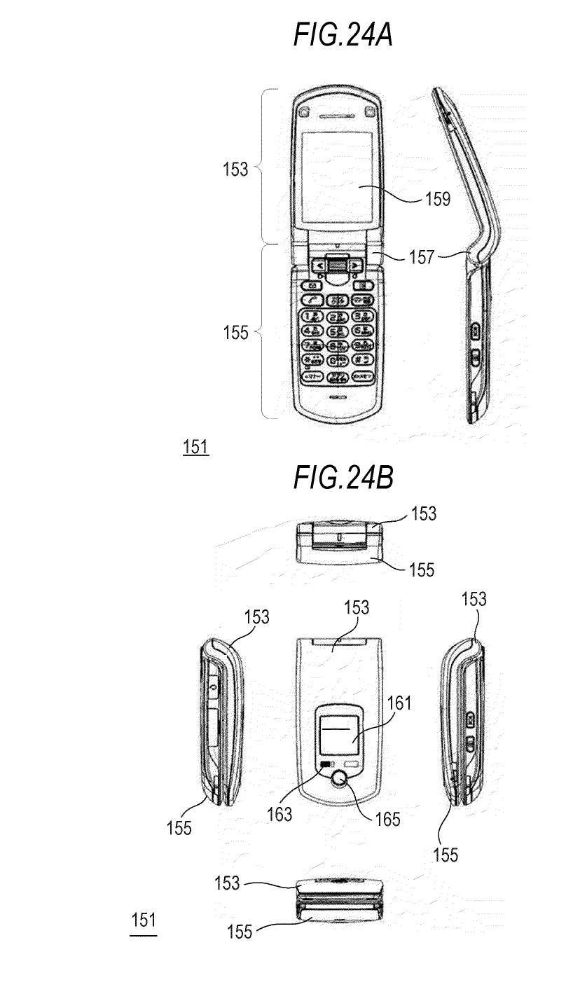

The electronic apparatus 101 may be, for example, a personal digital assistant. FIGS. 24A and 24B show an appearance example of a mobile phone 151 as a personal digital assistant. The mobile phone 151 shown in FIGS. 24A and 24B is a folder type mobile phone. FIG. 24A shows an appearance example of the mobile phone in an unfolded state, and FIG. 24B shows an appearance example of the mobile phone in a folded state.

The mobile phone 151 includes an upper housing 153, a lower housing 155, a connection portion (in this example, a hinge) 157, a display screen 159, an auxiliary display screen 161, a picture light 163, and an imaging lens 165. Of these, the display screen 159 and the auxiliary display screen 161 correspond to the liquid crystal panel according to the embodiment.

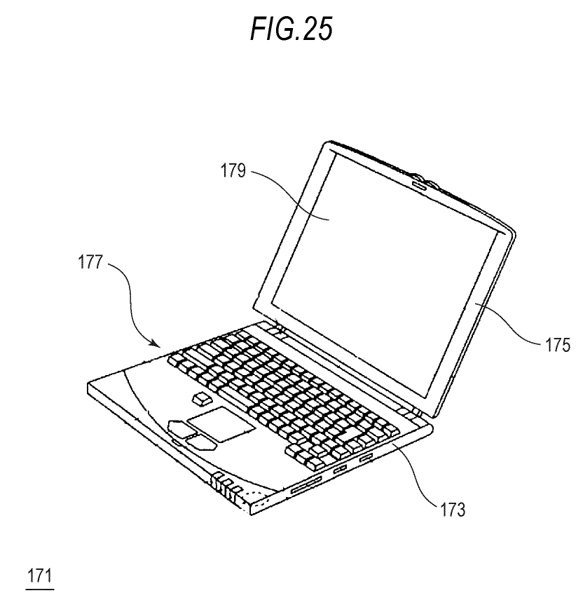

The electronic apparatus 101 may be, for example, a computer. FIG. 25 shows an appearance example of a notebook computer 171.

The notebook computer 171 includes a lower housing 173, an upper housing 175, a keyboard 177, and a display screen 179. Of these, the display screen 179 corresponds to the liquid crystal panel according to the embodiment.

In addition to the above-described electronic apparatuses, the electronic apparatus 101 may be, for example, a projector, an audio player, a game machine, an electronic book, an electronic dictionary, or the like.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A liquid crystal panel comprising:
first and second substrates arranged to be opposite each other at a predetermined gap;
a liquid crystal layer filled between the first and second substrates;
a counter electrode pattern formed on the first substrate;
a pixel electrode pattern formed on the first substrate; and
alignment films formed such that the alignment direction of the liquid crystal layer crosses the extension direction of a slit of the pixel electrode pattern at an angle of 7° or larger.

2. The liquid crystal panel according to claim 1,
wherein the cross angle between the extension direction of the slit and the alignment direction of the liquid crystal layer is equal to or larger than 7° and equal to or smaller than 15°.

3. The liquid crystal panel according to claim 1,
wherein the pixel electrode pattern and the counter electrode pattern are formed on the same layer surface.

4. The liquid crystal panel according to claim 1,
wherein the pixel electrode pattern and the counter electrode pattern are formed on different layer surfaces.

5. The liquid crystal panel according to any one of claim 1,
wherein each pixel region includes a plurality of regions where the rotation direction of liquid crystal molecules during voltage application differs.

6. An electronic apparatus comprising:
an liquid crystal panel, the liquid crystal panel including first and second substrates arranged to be opposite each other at a predetermined gap, a liquid crystal layer filled between the first and second substrates, a counter electrode pattern formed on the first substrate, a pixel electrode pattern formed on the first substrate, and alignment films formed such that the alignment direction of the liquid crystal layer crosses the slit extension direction of the pixel electrode pattern at an angle of 7° or larger;
a driving circuit driving the liquid crystal panel;
a system control unit controlling the operation of the entire system; and
an operation input unit receiving an operation input to the system control unit.
